(19) United States
(12) Patent Application Publication
(10) Pub. No.: US 2007/0089486 A1
(43) Pub. Date: Apr. 26, 2007

(54) Impact absorbing structure of gas sensor

(75) Inventors: Masanobu Yamauchi, Kariya-shi (JP); Takashi Kojima, Kasugai-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/541,703

(22) Filed: Oct. 3, 2006

(30) Foreign Application Priority Data
Oct. 4, 2005 (JP) 2005-291032
May 26, 2006 (JP) 2006-146671

(51) Int. Cl. G01N 7/00

(52) U.S. Cl. 73/31.05

(57) ABSTRACT

A gas sensor includes a sensor element holder, a porcelain insulator, an outer cover disposed on a housing to surround the porcelain insulator, and a sensor element disposed in the housing. The gas sensor also includes outside springs and at least one pair of terminal springs each of which is disposed between the porcelain insulator and the sensor element in abutment with the sensor element. The terminal springs work to form a nip in which a thickness of the sensor element is retained. The outside springs are disposed between the porcelain insulator and the outer cover and have a combined spring constant which is greater than or equal to that of the terminal springs, thereby causing external pressure to be transmitted more to the outside springs than to the terminal springs to suppress vibrations of the porcelain insulator effectively to avoid application of an undesirable impact to the sensor element.

### CROSS REFERENCE TO RELATED DOCUMENT

The present application claims the benefits of Japanese Patent Application No. 2005-291032 filed on Oct. 4, 2005 and Japanese Patent Application No. 2006-146671 filed on May 26, 2006 disclosures of which are incorporated herein by reference.

### BACKGROUND OF THE INVENTION

1 Technical Field of the Invention

The present invention relates generally to a gas sensor which may be installed in an exhaust system of an internal combustion engine for engine burning control, and more particularly to an improved structure of a gas sensor designed to absorb external pressure acting on the gas sensor for protecting a sensor element from the impact.

2 Background Art

FIG. 11 shows an example of typical gas sensors which is to be installed in an exhaust system of automotive internal combustion engines to measure the concentration of a component of exhaust emissions of the engine, such as oxygen (O₂) or nitrogen oxide (NOx).

The gas sensor includes a sensor element 92, a housing 94, a first porcelain insulator (i.e., an element-side porcelain insulator) 93, a second porcelain insulator (i.e., an atmosphere-side porcelain insulator) 95, and an air cover 96. The first porcelain insulator 93 is retained inside the housing 94. The sensor element 92 is installed inside the first porcelain insulator 93. The second porcelain insulator 95 surrounds a base portion 921 of the sensor element 92. The air cover 96 is joined to the housing 94 and surrounds the second porcelain insulator 95.

If either of opposed end surfaces of the first porcelain insulator 93 and the second porcelain insulator 95 is uneven, and the second porcelain insulator 95 is placed on and pressed against the first porcelain insulator 93 in order to align the second porcelain insulator 95 with the sensor element 92, it will cause the bending stress to act on the sensor element 92 and, in the worst case, result in breakage thereof. The second porcelain insulator 95 is, therefore, disposed above the first porcelain insulator 93 through an air gap and retained in a floating condition inside the air cover 96.

However, if external pressure F arising from, for example, mechanical vibrations or physical impact, is exerted, as demonstrated in FIG. 12, on the gas sensor, it will cause the second porcelain insulator 95 to move laterally, so that the bending stress is applied to the sensor element 92 through the terminal springs 94. Specifically, one of the terminal springs 94 and the other one 95 will produce unbalanced spring pressures f and f′. This causes a pressure of |f-f′| to act on the base portion 921 of the sensor element 92, which may lead to the damage to the sensor element 92.

In order to avoid the above problem, Japanese Patent First Publication No. 2004-144732 teaches use of springs which are disposed between an air cover (equivalent to the air cover 96 of FIG. 11) and a porcelain insulator (equivalent to the second porcelain insulator 95) to elastically retain the porcelain insulator spatially within the air cover.

The porcelain insulator is made of a complicated assembly of a plurality of parts, thus resulting in an increase in total production cost of the gas sensor. Further, if a large scale impact acts on the gas sensor, it may cause the impact to be transmitted directly from the springs to the porcelain insulator, thus applying the bending stress to the sensor element.

### SUMMARY OF THE INVENTION

It is therefore a principal object of the invention to avoid the disadvantages of the prior art.

It is another object of the invention to provide an improved structure of a gas sensor which is designed to absorb external pressure acting on the gas sensor for protecting a sensor element from the impact.

According to one aspect of the invention, there is provided a gas sensor which may be installed in an exhaust system of an automotive internal combustion engine to measure the concentration of a selected component of exhaust emissions for use in burning control of the engine. The gas sensor comprises: (a) an element holder having a top end and a base end opposed to the top end; (b) a sensor element having a length which includes a sensing portion and a base portion and is held firmly in the element holder with the base portion extending outside the base end of the element holder, the sensing portion working to produce a signal as a function of concentration of a selected component of gases; (c) a hollow housing having a top portion and a base portion opposed to the top portion, the housing retaining therein the element holder; (d) a hollow porcelain insulator disposed above the base end of the element holder to surround the base portion of the sensor element; (e) an outer cover disposed on the base portion of the housing to surround the porcelain insulator; (f) at least one pair of terminal springs each of which is disposed between an inner wall of the porcelain insulator and the sensor element in abutment with the base portion of the sensor element, the terminal springs being opposed to each other to form a nip in which a thickness of the base portion of the sensor element is retained; and (g) outside springs which are disposed between the porcelain insulator and the outer cover and allowed to be compressed or expanded in a direction of the nip. The outside springs has a combined spring constant which is greater than or equal to that of the terminal springs.

When a large scale impact acts on the gas sensor, it will cause the outside springs to be compressed or expand to move the porcelain insulator to or away from the outer cover. Simultaneously, the terminal springs are compressed or expand in the same direction as that of the outside springs, thereby causing the bending stress to be exerted on the sensor element. The impact is, however, distributed to the outside springs and the terminal springs, thus decreasing the degree of the impact acting on the sensor element to avoid undesirable physical damage to the sensor element.

The combined spring constant of the outside springs is, as described above, greater than or equal to that of the terminal springs, thus causing the impact to be transmitted more to the outside springs than to the terminal springs to suppress vibrations of the porcelain insulator effectively. A large load is not accumulated in the terminal springs, thus avoiding application of an undesirable pressure to the sensor element.

In the preferred mode of the invention, the gas sensor may further comprise an inner protective cylinder disposed inside the outer cover. The outside springs may be disposed between the inner protective cylinder and the porcelain insulator.

According to the second aspect of the invention, there is provided a gas sensor which comprises: (a) an element holder having a top end and a base end opposed to the top end; (b) a sensor element having a length which includes a sensing portion and a base portion and is held firmly in the element holder with the base portion extending outside the base end of the element holder, the sensing portion working to produce a signal as a function of concentration of a selected component of gases; (c) a hollow housing having a top portion and a base portion opposed to the top portion, the housing retaining therein the element holder; (d) a hollow porcelain insulator disposed above the base end of the element holder to surround the base portion of the sensor element; (e) an outer cover disposed on the base portion of the housing to surround the porcelain insulator; (f) at least one pair of terminal springs each of which is disposed between an inner wall of the porcelain insulator and the base portion of the sensor element in abutment with the base portion of the sensor element, the terminal springs being opposed to each other to form a nip in which a thickness of the base portion of the sensor element is retained; and (g) outside springs which are disposed between the porcelain insulator and the outer cover and allowed to be compressed or expanded in a direction of the nip so that a maximum stroke of the outside springs is less than or equal to that of the terminal springs.

When a large scale impact has acted on the gas sensor, and the porcelain insulator has moved to or away from the outer cover, it will cause the spring terminals not to be compressed or expand fully, thus decreasing the degree of the impact exerted on the sensor element as bending stress to avoid application of undesirable physical damage to the sensor element.

In the preferred mode of the invention, the gas sensor may further comprise an inner protective cylinder disposed inside the outer cover. The outside springs may be disposed between the inner protective cylinder and the porcelain insulator.

The outside springs may have a combined spring constant which is greater than or equal to that of the terminal springs.

According to the third aspect of the invention, there is provided a gas sensor which comprises: (a) a hollow cylindrical sensor element having a length which includes a sensing portion and a base portion, the sensing portion working to produce a signal as a function of concentration of a selected component of gases; (b) a hollow housing having a top portion and a base portion opposed to the top portion, the hollow housing retaining therein the sensor element with the base portion of the sensor element extending outside the base portion of the housing; (c) a heater having a length which includes a top portion and a base portion, the top portion being disposed inside the sensor element, the base portion extending outside the base portion of the sensor element; (d) a hollow porcelain insulator disposed above the base end of the element holder to surround the base portion of the sensor element; (e) an outer cover disposed on the base portion of the housing to surround the porcelain insulator; (f) at least one pair of terminal springs each of which is disposed inside the porcelain insulator in abutment with the base portion of the heater to nip the base portion of the heater from a radius direction of the heater; and (g) outside springs which are disposed between the porcelain insulator and the outer cover and allowed to be compressed or expanded in a direction in which the base portion of the heater is nipped. The outside springs has a combined spring constant which is greater than or equal to that of the terminal springs.

When a large impact acts on the gas sensor, it is, as described above in the first aspect of the invention, distributed to the outside springs and the terminal springs, thus decreasing the degree of the impact acting on the heater to avoid undesirable physical damage to the sensor element.

In the preferred mode of the invention, the gas sensor may further comprise an inner protective cylinder disposed inside the outer cover. The outside springs may be disposed between the inner protective cylinder and the porcelain insulator.

According to the fourth aspect of the invention, there is provided a gas sensor which comprises: (a) a hollow cylindrical sensor element having a length which includes a sensing portion and a base portion, the sensing portion working to produce a signal as a function of concentration of a selected component of gases; (b) a hollow housing having a top portion and a base portion opposed to the top portion, the hollow housing retaining therein the sensor element with the base portion of the sensor element extending outside the base portion of the housing; (c) a heater having a length which includes a top portion and a base portion, the top portion being disposed inside the sensor element, the base portion extending outside the base portion of the sensor element; (d) a hollow porcelain insulator disposed above the base end of the element holder to surround the base portion of the sensor element; (e) an outer cover disposed on the base portion of the housing to surround the porcelain insulator; (f) at least one pair of terminal springs each of which is disposed inside the porcelain insulator in abutment with the base portion of the heater to nip the base portion of the heater from a radius direction of the heater; and (g) outside springs which are disposed between the porcelain insulator and the outer cover and allowed to be compressed or expanded in a direction in which the base portion of the heater is nipped so that a maximum stroke of the outside springs is less than or equal to that of the terminal springs.

When a large scale impact has acted on the gas sensor, and the porcelain insulator has moved to or away from the outer cover, it will cause the spring terminals not to be compressed or expand fully, thus decreasing the degree of the impact exerted on the heater as bending stress to avoid application of undesirable physical damage to the sensor element.

In the preferred mode of the invention, the gas sensor may further comprise an inner protective cylinder disposed inside the outer cover. The outside springs may be disposed between the inner protective cylinder and the porcelain insulator.

The outside springs may have a combined spring constant which is greater than or equal to that of the terminal springs.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a longitudinal sectional view which shows a gas sensor according to the first embodiment of the invention;

FIG. 2 is a transverse sectional view, as taken along the line A-A in FIG. 1;

FIG. 3 is a schematic view of FIG. 2 which demonstrate pressures, as produced by outside springs and terminals springs;

FIG. 4 is a partially longitudinal schematic view which represents pressures, as produced by outside springs and terminals springs;

FIG. 5 is a partially longitudinal schematic view which represents ranges of strokes of outside springs and terminals springs in the second embodiment of the invention;

FIG. 6 is a partially longitudinal sectional view which demonstrates motion of a second porcelain insulator when subjected to a large scale physical impact;

FIGS. 7(a) and 7(c) are longitudinal sectional views which show a terminal spring and an outside spring placed in a steady state, respectively;

FIGS. 7(b) and 7(d) are longitudinal sectional views which show a terminal spring and an outside spring placed in a fully compressed state, respectively;

FIG. 8 is a longitudinal sectional view which shows a gas sensor according to the third embodiment of the invention;

FIG. 9 is a longitudinal sectional view which shows a gas sensor according to the fourth embodiment of the invention;

FIG. 10 is a transverse sectional view, as taken along the line B-B in FIG. 9;

FIG. 11 is a longitudinal sectional view which shows a conventional gas sensor; and

FIG. 12 is a partially longitudinal sectional view which demonstrates motion of an atmosphere-side porcelain insulator when subjected to physical impact.

### DESCRIPTION OF THE PREFERRED EMBODIMENTS

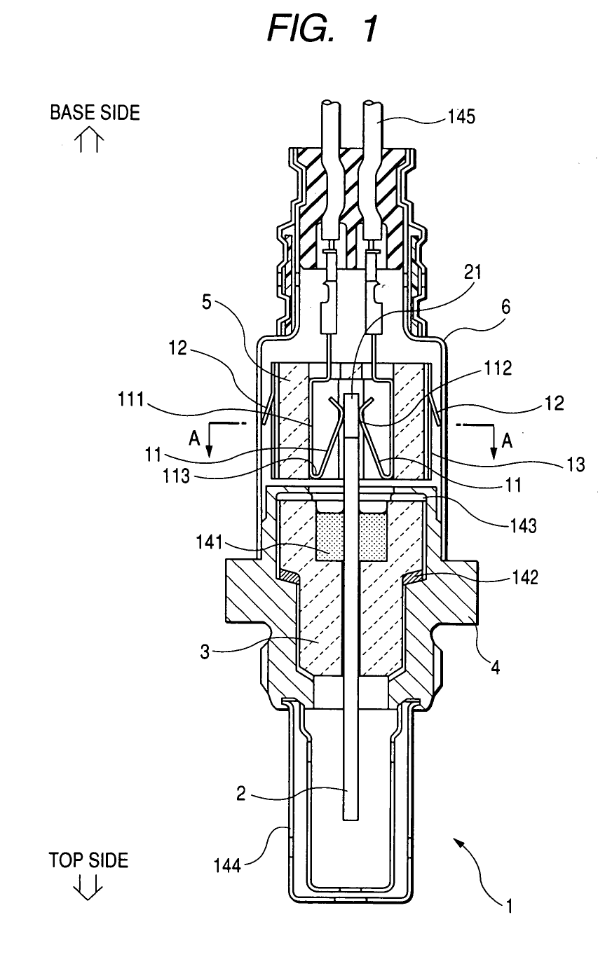

Referring to the drawings, wherein like reference numbers refer to like parts in several views, particularly to FIG. 1, there is shown a gas sensor 1 according to the first embodiment of the invention which may be employed in a burning control system for automotive vehicles to measure concentrations of components such as NOx, CO, HC, and O₂ contained in exhaust gasses of an internal combustion engine.

The gas sensor 1 generally includes a sensor element 2, a first hollow cylindrical porcelain insulator 3, a second hollow cylindrical porcelain insulator 5 which is to be exposed to air during use of the gas sensor 1, a hollow cylindrical housing 4, an air cover 6 which is to be exposed directly to air during use of the gas sensor 1, and a protective cover assembly 144. The sensor element 2 may be made of a laminated plate which consists essentially of a solid-electrolyte layer(s), an insulating layer(s), and a heater. For example, U.S. Pat. No. 5,573,650, issued on Nov. 12, 1996 to Fukaya et al. teaches a typical laminated sensor element, disclosure of which is incorporated herein by reference.

The first porcelain insulator 3 is fitted within the housing 4 and holds therein the sensor element 2. The second porcelain insulator 5 is aligned with the first porcelain insulator 3 and surrounds a base portion 21 of the sensor element 2. The air cover 6 is installed at an end thereof on the housing 4 to cover the second porcelain insulator 5. The protective cover assembly 144 has a double-walled structure and is installed and staked in an annular groove formed in an and of the housing 4 to cover a sensing portion of the sensor element 2.

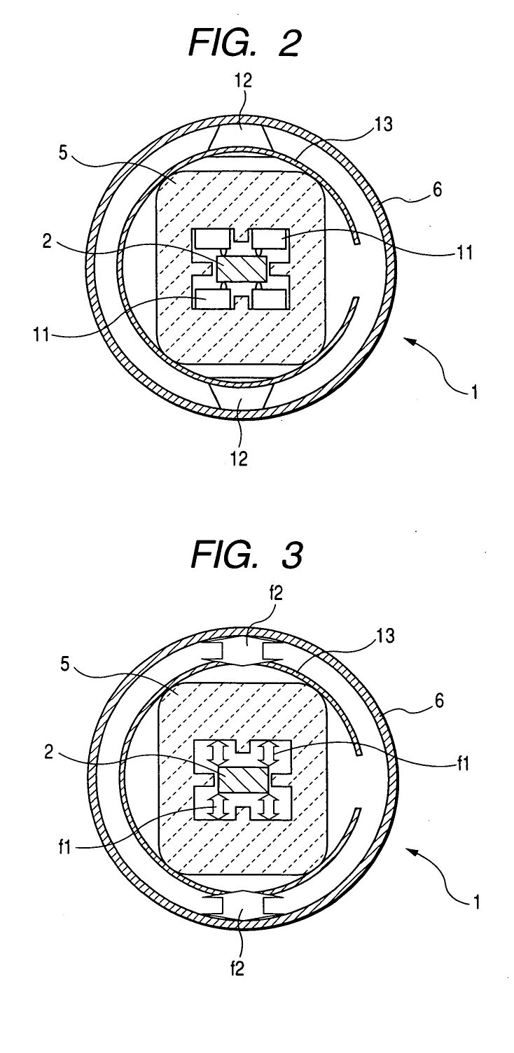

The gas sensor 1 also includes two pairs of terminal springs 11, as illustrated in FIGS. 1 and 2, which are disposed inside the second porcelain insulator 5 in electrical contact with the based portion 21 of the sensor element 2. The terminal springs 11 are placed in elastic abutment with the inner wall of the second porcelain insulator 5 to form a nip in which the thickness of the sensor element 2 is retained firmly. The only two terminal springs 11 may alternatively be installed in the second porcelain insulator 5.

The gas sensor 1 also includes outside springs 12 which are, as can be seen from FIG. 2, diametrically opposed to each other through the thickness of the sensor element 2. The outside springs 12 are disposed between the second porcelain insulator 5 and the air cover 6 so that they are allowed to be compressed or expand in a thickness-wise direction of the sensor element 2 (i.e., a direction in which the terminal springs 11 nips or grasps the sensor element 2) when under going the physical impact. The outside springs 12 are placed in a compressed state to apply elastic pressure to the second porcelain insulator 5, but may alternatively be joined to the inner wall of the air cover 6 so that they are placed in an expanded state. A combined spring constant of the outside springs 12 is greater than or equal to that of the terminal springs 11. The combined spring constant of the outside springs 12, as referred to herein, is the spring constant of an assembly of the outside springs 12 itself. The same is true for the combined spring constant of the terminal springs 11.

The second porcelain insulator 5 is, as illustrated in FIG. 2, fitted elastically in a hollow cylindrical holder 13 which has a slit to define a substantially C-shaped in cross section. The holder 13 faces the inner wall of the air cover 6 through an annular gap within which the outside springs 12 are disposed. The outside springs 12 are tabs which extend outwardly and diagonally from the holder 13 and abut the inner wall of the air cover 6 elastically so as to produce spring pressures exerted on the holder 13 in opposite directions.

The second porcelain insulator 5 is made of, for example, a ceramic material such as alumina (Al₂O₃) or steatite (MgO [symbol] SiO₂).

The sensor element 2 is, as described above, formed by a laminate of ceramic plates made of Alumina (Al₂O₃) and zirconia (ZrO₂) which is equipped with a sensor cell (not shown) working to produce an output as a function of the concentration of O₂ or nitrogen oxide (NOx) contained in, for example, exhaust emissions of an automotive internal combustion engine and a heater (not shown) working to keep the temperature of the sensor cell at a desired value.

The sensor element 2 is disposed in the first porcelain insulator 3. The first porcelain insulator 3 holds a middle portion of the sensor element 2 hermetically through a glass seal 141 and is retained within the housing 4 hermetically through a ring-shaped gasket 142. The housing 4 has an open end (i.e., an upper end, as viewed in FIG. 1) crimped to urge the first porcelain insulator 3 through an annular disc spring 143 elastically against an inner shoulder of the housing 4 through the gasket 142 to establish a hermetical seal between the first porcelain insulator 3 and the housing 4.

The second porcelain insulator 5 is not retained by sensor element-holding parts, such as the housing 4 and the first porcelain insulator 3. Specifically, the second porcelain insulator 5 is floated from the first porcelain insulator 3 through an air gap and retained indirectly by the air cover 6 and the sensor element 2 through the terminal springs 11 and the outside springs 12.

The protective cover assembly 144 is, as described above, joined to the end of the housing 4 to cover the sensing portion of the sensor element 2. The protective cover assembly 144 has formed therein gas inlets and defines a gas chamber within which the sensing portion of the sensor element 2 is exposed to the gas admitted from the gas inlets.

The four terminal springs 11 are, as can be seen in FIG. 2, disposed inside the second porcelain insulator 5 in electrical connection with leads 145 extending outside the gas sensor 1 to an external sensor controller (not shown). Two of the terminal springs 11 are in electrical contact with output terminals of the sensor cell of the sensor element 2. The other two terminal springs 11 are in electrical contact with power supply terminals affixed to the surface of the sensor cell for supplying electrical power to the heater.

Each of the terminal springs 11 is made of a C-shaped metallic plate which consists of a back strip 111, a front strip 112, and a bend 113 connecting between the back strip 111 and the front strip 112. The back strip 111 is placed in abutment with the inner wall of the second porcelain insulator 5, while the front strip 112 is placed in elastic abutment with the sensor element 2.

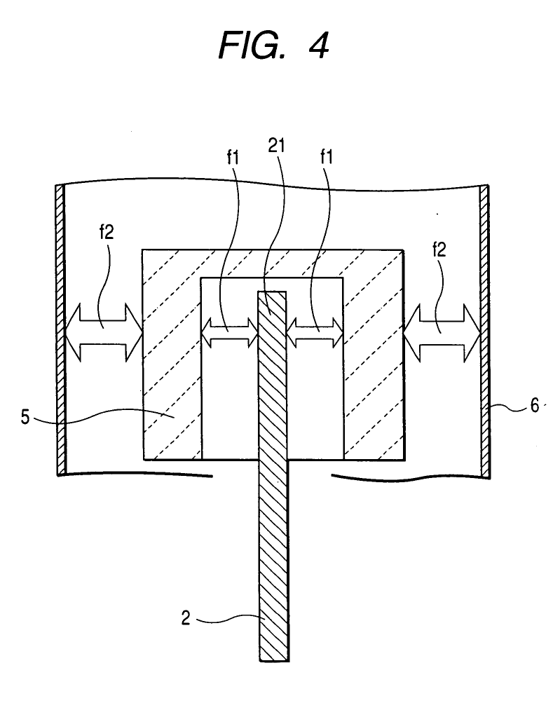

As shown in FIGS. 3 and 4, the terminal springs 11 and the outside springs 12 are geometrically oriented so that the pressure f1, as produced by each of the terminal springs 11, and the pressure f2, as produced by each of the outside springs 12, are directed in the same direction, i.e., in the thickness-wise direction of the sensor element 2. It is noted that FIGS. 3 and 4 omit the terminal springs 11 and the outside springs 12 and show only arrows representing the pressures, as produced by the terminal springs 11 and the outside springs 12, for the brevity of illustration.

The structural features of the gas sensor 1 will be described below.

The outside springs 12 are, as described above, disposed between the second porcelain insulator 5 and the air cover 6 to retain the second porcelain insulator 5 spatially inside the air cover 6, thereby suppressing vibrations of the second porcelain insulator 5 when physical impact acts on the gas sensor 1 from outside thereof. In other words, the outside springs 12 and the terminals springs 11 work to reduce the transmission of the impact acting on the gas sensor 1 to the sensor element 2 through the second porcelain insulator 5.

Specifically, when the external pressure acts on the gas sensor 1, it will cause the outside springs 12 to be compressed or expand cyclically, so that the second porcelain insulator 5 moves toward or away from the air cover 6. The terminal springs 11 vibrate in the same direction as that in which the outside springs 12 vibrate. This causes a bending stress to be exerted on the sensor element 2 through the terminal springs 11. The external pressure is, however, distributed to all of the outside springs 12 and the terminal springs 11 and absorbed thereby to suppress the vibrations of the second porcelain insulator 5, thus reducing the bending pressure acting on the sensor element 2 to minimize physical damage thereto.

The combined spring constant k2 of the outside springs 12 is, as described above, greater than or equal to the combined spring constant k1 of the terminal springs 11, so that the impact acting on the gas sensor 1 is transmitted more to the outside springs 12 than to the terminal springs 11. This causes the pressure accumulated in the terminal springs 11 to be smaller than that in the outside springs 12, thereby decreasing the degree of pressure acting on the sensor element 2. In other words, the outside springs 12 work to decrease the vibrations of the second porcelain insulator 5, thus decreasing the degree of impact acting on the sensor element 2 through the terminal springs 11.

For instance, when the second porcelain insulator 5 moves laterally by a distance ΔL, the pressure F2, as produced by the outside springs 12, acting on the second porcelain insulator 5 is expressed by F2=k2×ΔL. The pressure F1 exerted on the four terminal springs 11 is expressed by F1=k1×ΔL. Since k1≦k2, we obtain F1≦F2. The external pressure is, thus, applied more to the outside springs 12, thus decreasing the degree of pressing exerted on the sensor element 2.

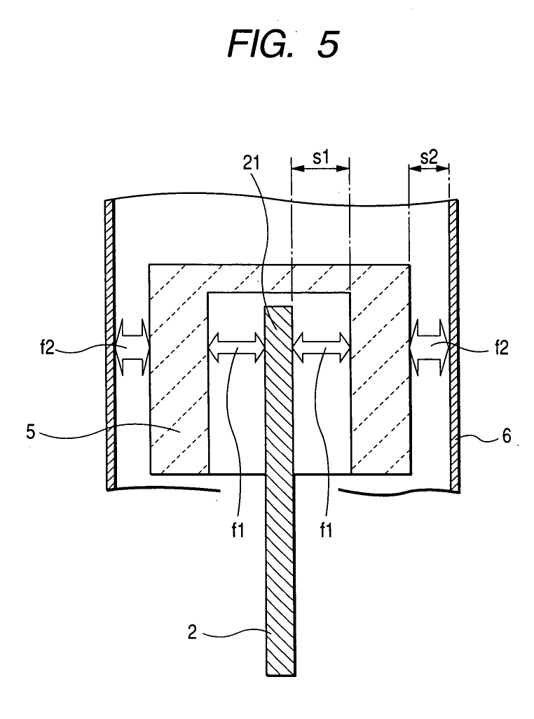

FIGS. 5 to 7(d) show the gas sensor 1 of the second embodiment of the invention which is so designed that a maximum stroke s2 of each of the outside springs 12 is selected to be less than or equal to a maximum stroke s1 of each of the terminal springs 11.

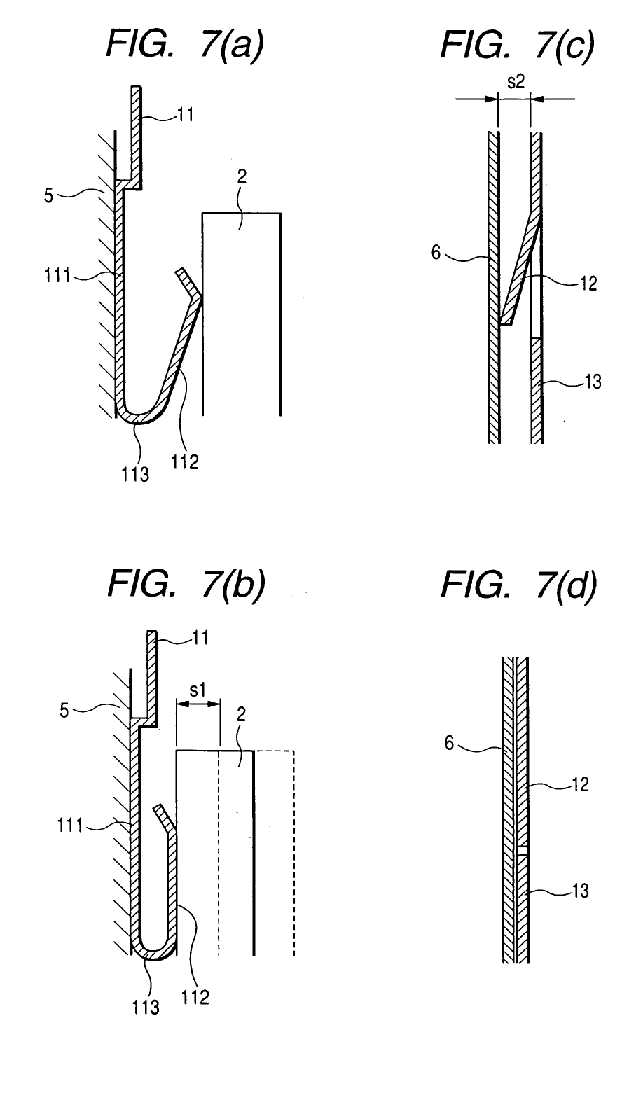

Each of the terminal springs 11 and the outside springs 12 has, as illustrated in FIGS. 7(a) to 7(b), a limitation in amount of compression. FIGS. 7(a) and 7(c) demonstrate the terminal spring 11 and the outside spring 12 which are placed in a steady state. FIGS. 7(b) and 7(d) demonstrate the terminal spring 11 and the outside spring 12 which are placed in a fully compressed state, in other words, subjected to the maximum strokes s1 and s2.

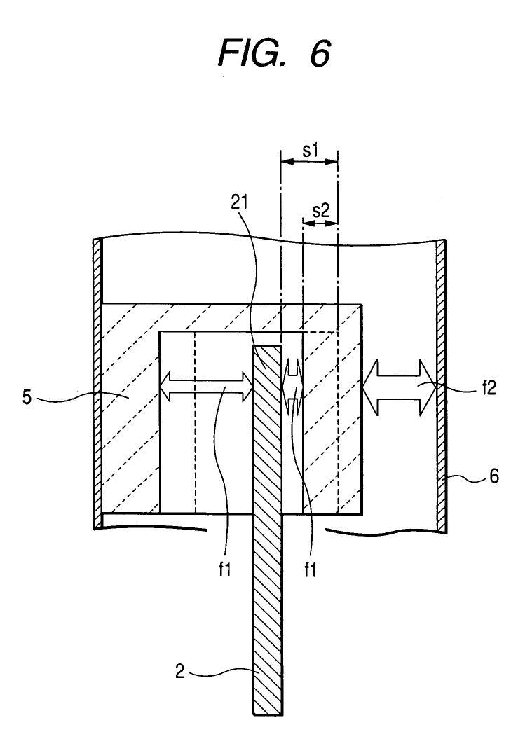

FIGS. 5 and 6 illustrate the steady state and the fully compressed state of the terminal springs 11 and the outside springs 12 when the thickness, i.e., the interval between the back strip 111 and the front strip 112 of the terminal spring 11 and the thickness of the outside spring 12 which are compressed fully are omitted, that is, defined to be zero (0) in order to facilitate the consideration of action of the terminal springs 11 and the outside springs 12. When no external pressure, as demonstrated in FIG. 5, acts on the gas sensor 1, the interval between the surface of the sensor element 2 and the inner wall of the second porcelain insulator 5 is the maximum stroke s1 of the front strip 112 of each of the terminal springs 11. Similarly, the interval between the surface of the second porcelain insulator 5 and the inner wall of the air cover 6 is the maximum stroke s2 of each of the outside springs 12. In practice, the maximum strokes s1 and s2 are shorter than the ones, as illustrated in FIG. 5, by the interval between the back strip 111 and the front strip 112 of the terminal spring 11 and the thickness of the outside spring 12, but the above definitions will be used in order to consider the difference between the maximum strokes s1 and s2 below.

The maximum stroke s2 of the outside springs 12 is selected to be less than or equal to the maximum stroke s1 of the spring terminals 11 (s2≦s1). Thus, when the external pressure, as demonstrated in FIG. 6, acts on the gas sensor 1, a maximum amount of movement of the second porcelain insulator 6 toward the air cover 6 will be the maximum stroke s2 of the outside springs 12. Specifically, if a large scale impact acts on the gas sensor 1, the second porcelain insulator 5 does not move by an amount greater than the maximum stroke s2 of the outside springs 12, thus decreasing the degree of the impact transmitted to the sensor element 2 through the second porcelain insulator 5.

For instance, when the second porcelain insulator 5 has moved fully, as demonstrated in FIG. 6, the pressure F1 max, as produced by the terminal springs 11, acting on the sensor element is expressed by F1max=k1×s2. The pressure F1max, thus, depends upon the maximum stroke s2. It is found that any pressure greater than the pressure F1max cannot be exerted on the sensor element 2.

If s2>S1, application of a great impact to the gas sensor 1 will cause the second porcelain insulator 5 to be moved further from where two of the terminal springs 11 expand fully, while the other two are compressed fully, so that the pressure exceeding the spring pressure of the terminal springs 11 acts on the sensor element 2, which may lead to physical breakage thereof.

The structure of the gas sensor 1 of this embodiment is so designed that when the great impact has acted on the gas sensor 1, and the second porcelain insulator 5 has moved fully to the air cover 6, the terminal springs 11 between the second porcelain insulator 5 and the sensor element 2 are not expanded or compressed fully and placed in condition where they are allowed to move further by a distance of s1-s2. This decreases the degree of the impact transmitted to the sensor element 2 through the second porcelain insulator 5.

The combined spring constant k2 of the outside springs 12 may be set, like the first embodiment, greater than or equal to the combined spring constant k1 of the terminal springs 11.

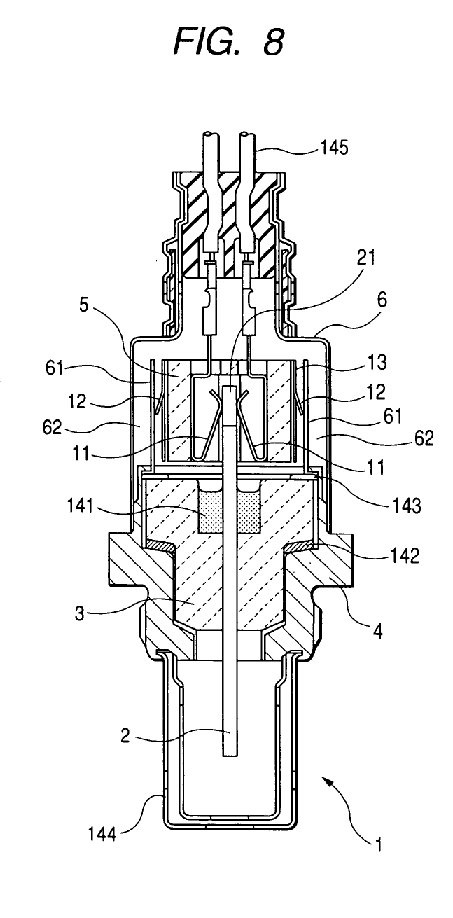

FIG. 8 shows the gas sensor 1 according to the third embodiment of the invention which has an inner protective cylinder 61 disposed inside the air cover 6.

The outside springs 12 of the hollow cylindrical holder 13 are disposed between the second porcelain insulator 5 and the inner protective cylinder 61 in abutment with an inner wall of the inner protective cylinder 61.

The inner protective cylinder 61 is joined to the housing 4 together with the disc spring 143 and the first porcelain insulator 3 by crimping a base end (i.e., an upper end, as viewed in FIG. 8) of the housing 4 inwardly. Other arrangements are identical with those in the first and second embodiments, and explanation thereof in detail will be omitted here.

When hit by, for example, a flying stone, the air cover 6 is allowed to be deformed within an air chamber 62 defined between the air cover 6 and the inner protective cylinder 61, thus blocking transmission of the impact to the outside springs 12 through the inner protective cylinder 61 to ensure the maximum stroke s2 of the outside springs 12. This establishes the relations between the pressures F1 and F2 and between the maximum strokes s1 and s2, as described above.

The installation of the inner protective cylinder 61 inside the air cover 6 results a decrease in the maximum stroke s2 of the outside springs 12 between the inner protective cylinder 61 and the second porcelain insulator 5, thus increasing a distance of s1-s2 the terminal springs 11 are allowed to move further when the great impact has acted on the gas sensor 1, and the second porcelain insulator 5 has moved fully to the air cover 6, thereby decreasing the degree of the impact transmitted to the sensor element 2 through the second porcelain insulator 5.

The terminal springs 11 and the outside springs 12 in each of the above embodiments may alternatively be made of coil springs or another type of springs or cushions.

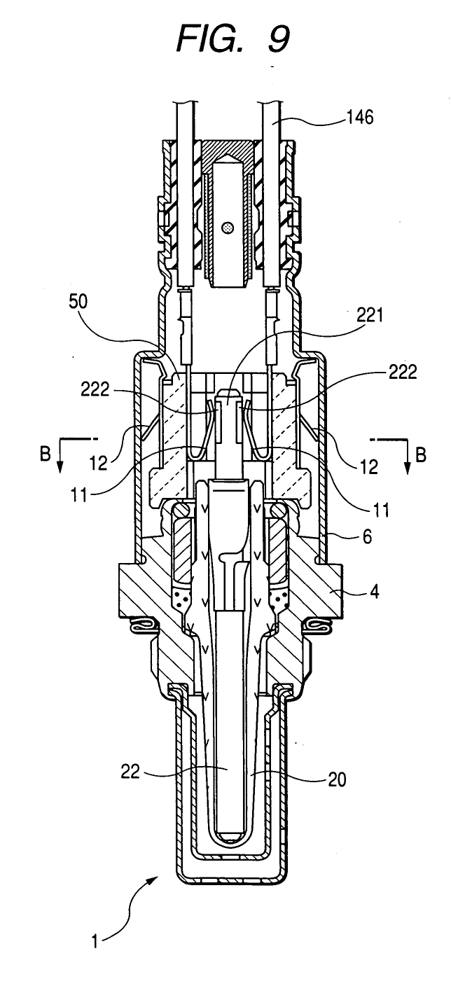

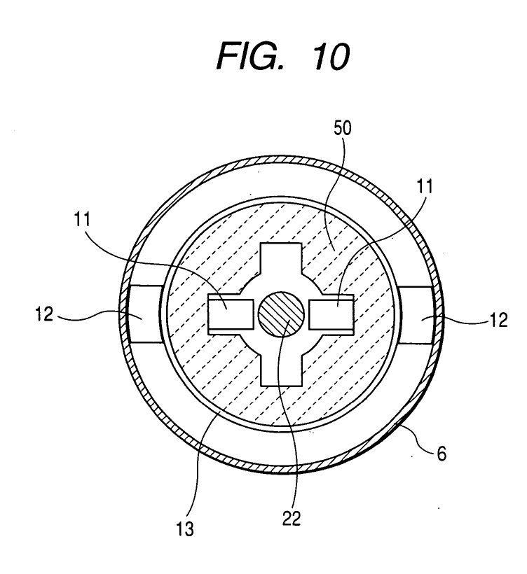

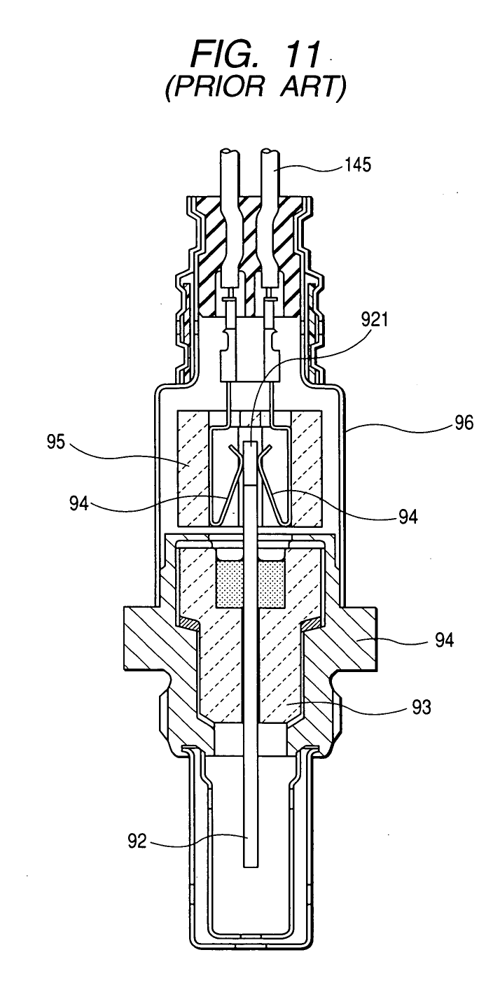

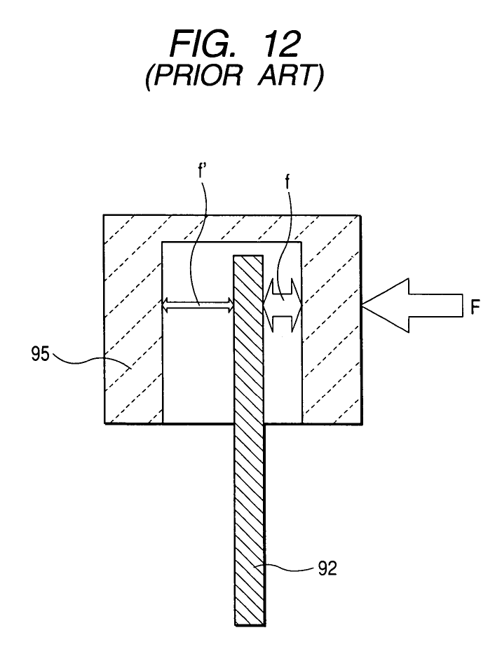

FIGS. 9 and 10 show the gas sensor of the fourth embodiment of the invention which is equipped with the sensor element 20 of a cup-shaped type.

The sensor element 20, as illustrated in FIG. 9, includes a solid electrolyte body with a bottom and a pair of electrodes (not shown) affixed to an outer and an inner surface of the solid electrolyte body. The sensor element 20 is retained inside the housing 4. A heater 22 is installed inside the sensor element 20 which heats the sensor element 20 up to a desired activation temperature. The heater 22 has a base portion 221 extending outside the base end (i.e., the upper end, as viewed in FIG. 9) of the housing 4. The heater 22 is implemented by a cylindrical ceramic heater made of alumina.

An air-side porcelain insulator 50 is disposed on the based end of the housing 4 in alignment therewith and covers the base portion 221 of the heater 22.

A pair of terminal springs 11 are, as can be seen from FIG. 10, disposed inside the air-side porcelain insulator 50 and opposed diametrically to each other. The terminal springs 11 are in elastic abutment with the inner wall of the air-side porcelain insulator 50 and the base portion 221 of the heater 22 to form a nip in which the heater 22 is retained firmly.

The heater 22 has formed on the base portion 221 terminals 222 which lead to a heating element and with which the terminal springs 11 are placed in contact to establish electrical communication between leads 146 and the heater 22.

The outside springs 12 are disposed between the air-side porcelain insulator 50 and the air cover 6 so as to create spring pressures oriented in the same direction as those of the terminal springs 11. The combined spring constant of the outside springs 12 is greater than or equal to that of the terminal springs 11. Other arrangements are identical with those of the first embodiment.

The structure of the gas sensor 1 of this embodiment works to reduce the transmission of physical impact to the heater 22 from outside the air cover 6 to minimize the breakage thereof based on the same principle as that of the first embodiment. This also protects the sensor element 2 through the heater 22 against the impact to avoid the breakage of the sensor element 2.

The maximum stroke s2 of the outside terminals 12 may be selected to be less than or equal to the maximum stroke s1 of the terminal springs 11 in order to protect the heater 22 and the sensor element 2 from the external pressure acting on the gas sensor 1 based on the same principle as described above.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A gas sensor comprising:
an element holder having a top end and a base end opposed to the top end;
a sensor element having a length which includes a sensing portion and a base portion and is held firmly in said element holder with the base portion extending outside the base end of said element holder, said sensing portion working to produce a signal as a function of concentration of a selected component of gases;
a hollow housing having a top portion and a base portion opposed to the top portion, said housing retaining therein said element holder;
a hollow porcelain insulator disposed above the base end of said element holder to surround the base portion of said sensor element;
an outer cover disposed on the base portion of said housing to surround said porcelain insulator;
at least one pair of terminal springs each of which is disposed between an inner wall of said porcelain insulator and said sensor element in abutment with the base portion of said sensor element, the terminal springs being opposed to each other to form a nip in which a thickness of the base portion of said sensor element is retained; and
outside springs which are disposed between said porcelain insulator and said outer cover and allowed to be compressed or expanded in a direction of the nip, said outside springs having a combined spring constant which is greater than or equal to that of said terminal springs.

2. A gas sensor as set forth in claim 1, further comprising an inner protective cylinder disposed inside said outer cover, and wherein said outside springs are disposed between said inner protective cylinder and said porcelain insulator.

3. A gas sensor comprising:
an element holder having a top end and a base end opposed to the top end;
a sensor element having a length which includes a sensing portion and a base portion and is held firmly in said element holder with the base portion extending outside the base end of said element holder, said sensing portion working to produce a signal as a function of concentration of a selected component of gases;
a hollow housing having a top portion and a base portion opposed to the top portion, said housing retaining therein said element holder;
a hollow porcelain insulator disposed above the base end of said element holder to surround the base portion of said sensor element;
an outer cover disposed on the base portion of said housing to surround said porcelain insulator;
at least one pair of terminal springs each of which is disposed between an inner wall of said porcelain insulator and the base portion of said sensor element in abutment with the base portion of said sensor element, the terminal springs being opposed to each other to form a nip in which a thickness of the base portion of said sensor element is retained; and
outside springs which are disposed between said porcelain insulator and said outer cover and allowed to be compressed or expanded in a direction of the nip so that a maximum stroke of said outside springs is less than or equal to that of said terminal springs.

4. A gas sensor as set forth in claim 3, further comprising an inner protective cylinder disposed inside said outer cover, and wherein said outside springs are disposed between said inner protective cylinder and said porcelain insulator.

5. A gas sensor as set forth in claim 3, wherein said outside springs has a combined spring constant which is greater than or equal to that of said terminal springs.

6. A gas sensor comprising:
a hollow cylindrical sensor element having a length which includes a sensing portion and a base portion, said sensing portion working to produce a signal as a function of concentration of a selected component of gases;
a hollow housing having a top portion and a base portion opposed to the top portion, said hollow housing retaining therein said sensor element with the base portion of said sensor element extending outside the base portion of said housing;
a heater having a length which includes a top portion and a base portion, the top portion being disposed inside said sensor element, the base portion extending outside the base portion of said sensor element;
a hollow porcelain insulator disposed above the base end of said element holder to surround the base portion of said sensor element;
an outer cover disposed on the base portion of said housing to surround said porcelain insulator;
at least one pair of terminal springs each of which is disposed inside said porcelain insulator in abutment with the base portion of said heater to nip the base portion of said heater from a radius direction of said heater; and
outside springs which are disposed between said porcelain insulator and said outer cover and allowed to be compressed or expanded in a direction in which the base portion of said heater is nipped, said outside springs having a combined spring constant which is greater than or equal to that of said terminal springs.

7. A gas sensor as set forth in claim 6, further comprising an inner protective cylinder disposed inside said outer cover, and wherein said outside springs are disposed between said inner protective cylinder and said porcelain insulator.

8. A gas sensor comprising:
a hollow cylindrical sensor element having a length which includes a sensing portion and a base portion, said sensing portion working to produce a signal as a function of concentration of a selected component of gases;
a hollow housing having a top portion and a base portion opposed to the top portion, said hollow housing retaining therein said sensor element with the base portion of said sensor element extending outside the base portion of said housing;
a heater having a length which includes a top portion and a base portion, the top portion being disposed inside said sensor element, the base portion extending outside the base portion of said sensor element;
a hollow porcelain insulator disposed above the base end of said element holder to surround the base portion of said sensor element;
an outer cover disposed on the base portion of said housing to surround said porcelain insulator;
at least one pair of terminal springs each of which is disposed inside said porcelain insulator in abutment with the base portion of said heater to nip the base portion of said heater from a radius direction of said heater; and
outside springs which are disposed between said porcelain insulator and said outer cover and allowed to be compressed or expanded in a direction in which the base portion of said heater is nipped so that a maximum stroke of said outside springs is less than or equal to that of said terminal springs.

9. A gas sensor as set forth in claim 8, further comprising an inner protective cylinder disposed inside said outer cover, and wherein said outside springs are disposed between said inner protective cylinder and said porcelain insulator.

10. A gas sensor as set forth in claim 8, wherein said outside springs has a combined spring constant which is greater than or equal to that of said terminal springs.
